(19) United States
(12) Patent Application Publication
(10) Pub. No.: US 2006/0047590 A1
(43) Pub. Date: Mar. 2, 2006

(54) REAL-TIME RISK MANAGEMENT TRADING SYSTEM FOR PROFESSIONAL EQUITY TRADERS WITH ADAPTIVE CONTINGENCY NOTIFICATION

(76) Inventors: Timothy Anderson, Menlo Park, CA (US); Mark Mooney, Petaluma, CA (US)

Correspondence Address: SUMMERS RUBINSTEIN, PROFESSIONAL CORP;PATENTS, 100 Pine Street, 20th Floor, SAN FRANSISCO, CA, 94111, US

(21) Appl. No.: 10/904,787

(22) Filed: Nov. 29, 2004

Related U.S. Application Data
(63) Continuation-in-part of application No. 10/961,553, filed on Oct. 8, 2004.
(63) Continuation-in-part of application No. 10/711,128, filed on Aug. 26, 2004.

(51) Int. Cl. G06Q 40/00

(52) U.S. Cl. 705/35

(57) ABSTRACT

The present invention provides traders with a computer-based neural analysis system for trading commodities based on a traders risk profile, particularly equities, by providing a careful selection of the data to analyze and selecting the correct manipulation of that data. The neural analysis component uses initially selected data components or factors, by manipulating them with operators, or asset specific mathematical functions, a fuzzy or Bayesian advisors help to assist in the genetic learning of the system by being reward and punishment based on the correlation to success and failure, or meta-advisors. A contingency notification system implemented either internally or externally examines the real-time data feed to determine if conditions are such that the trader should be notified that conditions have been met, such that the risk profile requires an immediate action.

### REFERENCE TO PRIORITY DOCUMENTS

This application is a continuation-in-part of and claims priority under 35 USC §120 to U.S. patent application Ser. No. 10/711,128, filed Aug. 26, 2004 and entitled COMPUTER-IMPLEMENTED ADAPTIVE MODULUAR RISK MANAGEMENT TRADING SYSTEM FOR PROFESSIONAL EQUITY TRADERS and also is a continuation-in-part and claims priority under 35 USC §120 to U.S. application Ser. No. 10/961,553, entitled REAL-TIME ADAPTIVE MODULAR RISK MANAGEMENT TRADING SYSTEM FOR PROFESSIONAL EQUITY TRADERS by Timothy Anderson and Mark Mooney, and filed Oct. 8, 2004, all of which are incorporated by reference for all purposes.

### BACKGROUND

This application incorporates all the features of an experimental stock trading program called STOCKO, developed by Dr. Robert Levinson of Santa Cruz, Calif., pursuant to the extent of the applicable law under 35 USC 1 et. seq. Information regarding the STOCKO platform has also been made available to the public through several Internet sites since 1997, including www.clearstation.com, www.i.exchange.com, www.stockscience.com and www.drstocko.com, all of which are fully incorporated by reference, for all purposes and discussed in the background to the present invention.

The prior art Artificial Intelligence based experimental STOCKO (herein “neural analyzer”) takes advantage of some assumptions that vary from embodiment to embodiment. For example, the market is not obligated to behave as it has in the past: some consequences of this on that even the best systems will probably stop working at some point and will probably only be profitable in certain environments. As the neural analyzer system incorporates more complexities, it should be able to remain on-target (or in the context of the present invention “profitable.”) FIGS. 1A-C, help illustrate the functional and structural operations of the experimental neural relation program so that it may be understood as to how to implement it in the present invention, which also incorporates third party operations software, which is discussed below. FIG. 1C shows a sample system for adjusting the operators or indicators is shown. The operators are generally mathematical and/or logical functions that transform the array data or factor data. Stored pre-defined sets or ad hoc selection of operators may be dependent of the class of the asset, but may also be chosen based on other factors, such as market conditions, etc.

Some principles of the operations of the neural analyzer when they are applied to equity trading are helpful. A few are discussed here:

the market may, at times, exhibit “inside pattern” or pattern cancellation behavior so that it appears to purposely break and or punish past useful patterns beyond what a purely random market might do:

given proper normalization in a canonization of past data, all securities in all-time frames exhibit behavior that is useful in helping to be date a future price movement had given time. For example, IBM's trading day tomorrow may resemble the any at index 255 days ago, especially from an analogy established between their current and underlying technical environments;

The Metropolis simulated annealing strategy of “heating up” (to encourage innovation) a system that is doing poorly and “cooling” a system that is doing well. This added randomness should keep systems out of ruts created by any particular mal-feature behavior;

forecasts can be further combined developed into risk-minimized portfolios by analyzing correlations between items, features and justifications for trades in the portfolio and creating various hedges. For example long—Amzn and short—YHOO;

the market forecasting system is complex enough to model its large technical training strategies at varying time frames in order to simulate the habits of populations of traders that follow, or appear to follow certain.

Given the security, certain forecasting strategies will have to be approved to be more useful than others at predicting recent stock behavior.

a stock forecasting strategy can never be very bad since it's very badness can be exploited by trading contrary to it. The only useless feature is that the forecasts are those that are essentially random. However, perversely, some features may manage to change their success as soon as they're exploited. Clearly it is these features that must be ignored or of avoided or exploded when properly recognized.

as long as mal-features and so-called overfitting can be avoided, adding new features to the system should improve performance in the long run once the system becomes adept at using such features.

### SUMMARY OF THE INVENTION

The primary embodiment of the invention is to provide a environment for managing predictive models. The invention incorporates the neural analyzer discussed above with a real-time or near real-time feed, to allow traders to implement market forecasting systems that are complex enough to model large technical training strategies at varying time frames in order to simulate the habits of populations of traders that follow, or appear to follow the strategies. Given the security, certain forecasting strategies will have to be approved to be more useful than others at predicting recent stock behavior.

The present invention provides the CyberTrader™ (CT) user (or other user using a similarly capably trading system), the ability to offer their active trader clients a trading system which would scientifically reduce their risk, while simultaneously increasing their trading volume. The present invention provides an advantage for users in the electronic brokerage industry, as the fight among competitors is over the tiny percentage of active traders who trade huge volumes of stocks on a daily basis and who generate significantly in excess of 50% of any given firm's trading volume.

The invention uses the neural analyzer to rely on the principle that a stock forecasting strategy can never be very bad since so-called “very badness” can be exploited by trading contrary to it. The only useless feature is that the forecasts are those that are essentially random. However, perversely, some features may manage to change their success as soon as they're exploited. Clearly it is these features that must be ignored or of avoided or exploded when properly recognized. This problem is addressed in another patent application assigned to the Applicant.

Thus, the invention uses the real-time feed in combination with the neural analyzer system discussed in the background sections. The forecast is developed as a function of: A. the past price behavior of the stock, B it's past price behaviors, and relationship to other securities in similar scenarios C. The relative success of various features implementing the neural analyzer with the present invention depend on predicting correctly or incorrectly recent price behavior. These features may come from the traditional technical analysis box, general and chaos theory, time-series analysis and other human or computer design features and “expertise modules”.

As long as mal-features and so called over-fitting can be avoided, adding new features to the system should improve performance once the system becomes adept at using such features. Additionally, the cycle of success and failures of individual features either in the neural analyzer or the invention external to it, may be needed as securities for which the forecasts become relevant possibly at a meta-level.

Because the invention must implement the neural analyzer on a trading system that has particularly desirable features, the invention is run on the CYBERTRADER® (trading application) and currently licensed by Schwab, although there is no reason why the invention cannot be run on any number of customized or off-the-shelf solutions. In order to make the invention particularly useful, this application fully incorporates technical, intellectual property, and marketing materials related to CYBERTRADER™®, currently licensed to Schwab (and its subsidiaries.) These are summarized in APPENDIX A.

### BRIEF DESCRIPTION OF THE DRAWINGS

FIG. 1A illustrates the basic interactive components of the predictive advisors in the prior art artificial intelligence equity analysis program or STOCKO;

FIG. 1B is a flow diagram of the operator selection in the prior art;

FIG. 2 illustrates sample data flow in the prior art equity analysis system;

FIG. 3A illustrates a sample data flow and architecture of the present invention;

FIG. 3B illustrates how the real-time feed can intentionally affect the flow of information;

FIG. 4 is an architectural implementation of the of the invention as it may be implemented on CyberTrader™® or another program of similar structure and where data feeds cab be placed;

FIG. 5 is an alternate view of the data flow shown in FIG. 1B in a preferred embodiment of the invention with the notification override system;

FIGS. 6A and 6B are sample screen shots and the resulting data of a preferred embodiment of the system as it would be used by a CYBERTRADER®;

FIG. 7 shows the invention providing “self-correcting” notification situations through the use of “contingency criteria” from the neural-relationships;

FIG. 8 illustrates a functional and component diagram of the “monitor layer” which seeks unusual data in the real-time data field and/or new neural relationships;

FIG. 9 illustrates a data flow that flags for particular factors under certain conditions;

FIG. 10 shows the iteration adjustment based on a tagged factor; this is discussed at length in co-application Ser. No. 10/961,553, which is incorporated by reference herein;

FIG. 11A shows a change in iteration based on factor-threshold detection;

FIG. 11B shows a change in iteration based on a new-found relational discovery by the neural advisors;

FIG. 11C illustrates a change in iteration based on a parameter (either fed by the data feed or generated internally) that is no longer within normal limits or is presently missing;

FIG. 11D illustrates a Bayesian “null set” or a “neural misfire” which means that a Bayesian logic operator has been set up or adjusted not to have a data to screen out;

FIG. 12 shows operator selection based on the illustrated criteria; and

FIG. 13 is illustrative of the adjustments to important contingency information reporting.

### DETAILED DESCRIPTION

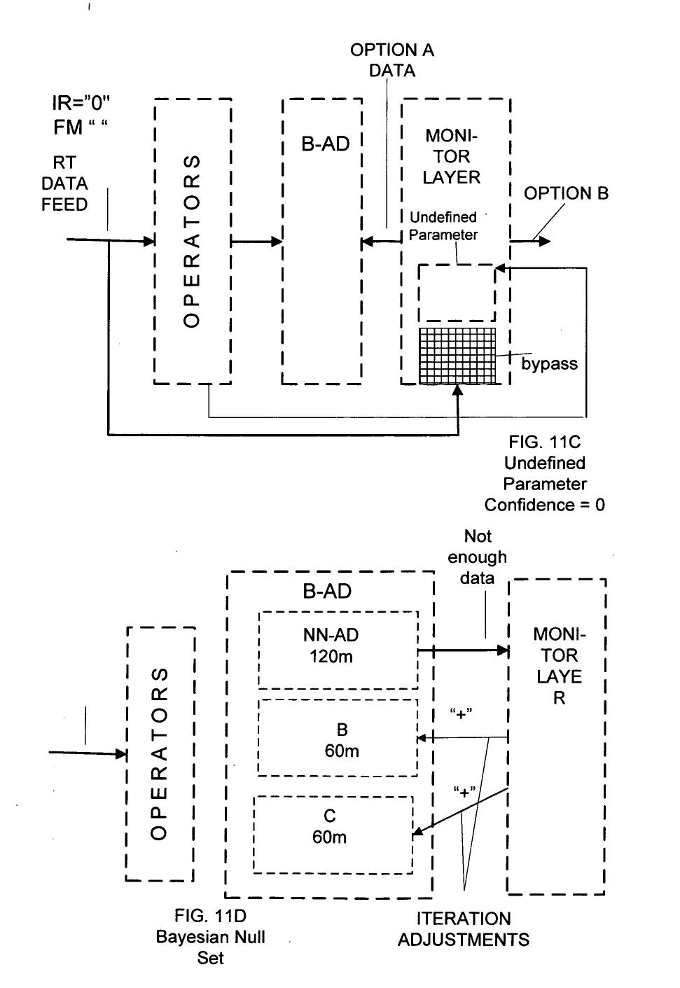

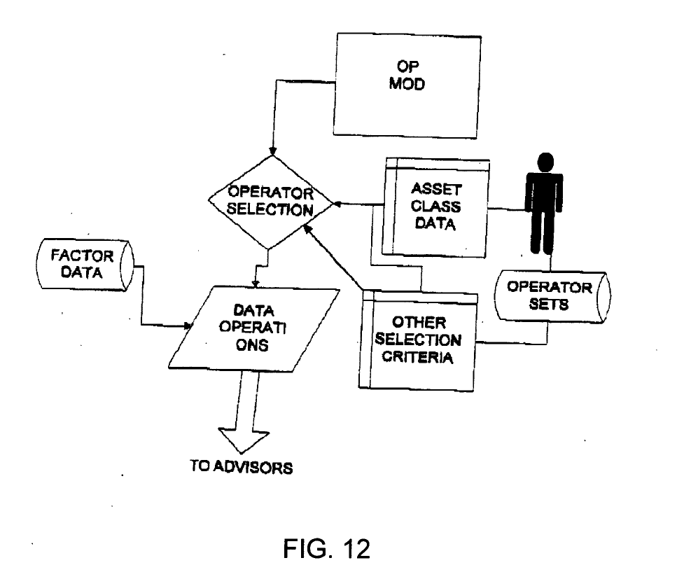

It is critical at the outset to point out, that specifically, in FIGS. 11-D. that contingency notification and not iteration adjustment is the key innovation in this patent application. Thus, while iterative adjustments are taking place, contingency notifications may be taking place for similar reasons.

The present invention takes advantage of numerous techniques and features which would lead to significantly increased trading volume in order to benefit the brokerage firms by giving them a competitive advantage within the active trader community. For example, writing specifically for the stock market would omit such markets as Foreign Exchange, Fixed Income, Futures, Options and other asset classes, all of which lend themselves to the powerful analytical capabilities of the base invention. The invention would provide many advantages to target markets by implementing the real time capability as non-asset specific. Every asset class has its own set of technical indicators and inputs similar to the stock market.

Furthermore, due to the fact that active traders require as much “executable” information at their fingertips as possible, a preferred embodiment of the invention operates in its own window on the CyberTrade™ Windows-based platform. This allows a trader to have immediate access to the most current forecasts for their stocks of interest, allowing the trader to execute immediately the trade from the same screen.

The present invention may include several sophisticated techniques and features which address the active trader market specifically and increase the likelihood of their extended viability by increasing their profitability and reducing their risk.

The relative success of various features depend on predicting correctly or incorrectly recent price behavior. These features may come from the traditional technical analysis box, general and chaos theory, time-series analysis and other human or computer design features and “expertise modules”. Additionally, the rhythm of the successes and failures of individual features, may be needed as securities for which the forecasts become relevant possibly at a meta-level.

Furthermore, in order to generate as many trading opportunities as possible for CT's clients, the present invention incorporates increasing the frequency of our forecasts. The original STOCKO only published “Buy”, “Sell”, or “Hold” recommendations for the next day's close. These forecasts were generated from the OHLC (“Open”, “High”, “Low”, “Close”) data from the day just ended. Increasing the frequency of the forecasts, ultimately approaches real time forecasts and is limited only by band width and processing power. Secondly, instead of implementing a simple Buy, Sell, Hold forecast, the present invention recommends an actual dollar price.

The present invention also calculates and displays confidence levels relating to the confidence in the direction of price movement, but also does not anticipate the magnitude. The next embodiment of the invention agreed to start implementing with magnitude confidence levels.

One of the key factors in successfully implementing the present invention is the selection of the data to analyze and select the correct manipulation of that data. Initially, it is useful to consider the concept of the data components of factors, operators, advisors, and overlay advisors, or meta-advisors as they are implemented by the neural analysis engine discussed in the background, and how they affect the performance of the present invention

A real time or near real-time forecast feed drives the adaptability of system to inform traders a critical junctures in the trading day. The ability to increase the frequency of predictions is directly related to the inclusion of the “decision factors” of choosing. Prior to the inclusion of these “real time” factors, the (prior art version) of the system was more reactive than pro-active. The goal immediately became to make the brokerage firms' clients more profitable (or less unprofitable) and to stimulate trading activity.

That was the reason so many changes and additions were required to both the inputs, outputs and timing thereof. Instead of simply producing Buy, Sell, Hold recommendations, the invention uses actual dollar prices. The invention then moved to forecasting a specific price movement for each stock, complete with direction of movement, magnitude of movement (both in % and in dollars), and confidence of movement.

Component: Class and Function

Factor: Array (Numerical Data, Correlation): the first component of factors may be a stock price or collection of data;

Operator: mathematical or logical function, transforms a factor into recognizable data;

Base-Advisors Bayesian Logic Modules; determines inclusion or exclusion of transformed data for an number of circumstances;

Meta-Advisor: sets fuzzy logic with adjustable parameters; analyzes multiple base advisors;

Risk Management Override Boolean: the override is a monitor that continually assesses market conditions and will generate a stop-loss/take-profit instruction when needed.

Choosing from a large number of more specifically targeted inputs to populate the parameters which include the factors and the set of operators that will be used. The major obstacle is that there literally tens of thousands of possible candidates for inclusion in the model.

The present invention obtains a complete global data set for research. The initial data set was chosen from those data items best suited for the general stock forecasting needs, as opposed to being limited to mutual funds or other items. The development of the invention called for analyzing and making forecasts for a basket of 50 stocks. The inputs most closely correlated to the expected price movement of the basket stocks. These inputs consisted of other stocks in the same industry as some of our target stocks, market indices, sector indices (such as SOX) certain commodity prices and fixed income futures prices.

For example, as may be appreciated by those skilled in the art, interest rates and interest expectations, drive all financial markets. Therefore, there must be a connection to interest rates included among the factors. They also “lead” the markets temporally, thus acting as an “early warning” or leading indicator of market moves that are about to occur. Certain interest rate securities or derivatives reflect the current demand for borrowing and the relationship of that demand to the currently available supply of money for lending. Other interest rate securities and derivatives are more useful in determining the market participants' expectations of interest rate movement, and the possible magnitude of that movement in the future.

Stop-loss/take-profit recommendations forced competitive traders to be provided with meaningful recommendations as there may be functionally dynamically generated information. Specifically, the traders had to be provided with information relevant to each of the current market environments. Stop-loss and take-profit levels are not a fixed distance from the recommended price and tree, but dynamically adjusted with each new prediction, sometimes with a particular relationship (positive correlation) to the current price, sometimes another (such as a negative correlation).

The invention must provide more than data or a take it or leave it trading proposition. If the customer is dynamically presented with scientifically calculated stop-loss and take-profit options and then must wait for a canned choice to accept it, it destroys any advantage he may have against more savvy trader or users that have access to different trading systems. The present invention allows customers to automatically load the alert function based upon me stop-loss and/or take-profit recommendations. These recommendations can be teamed or adjusted to meet specific savvy trader objectives as well as other platforms. For example, the take profit recommendations have been more conservative, to help ensure that read to customers cash or profit more frequently. In particular, that is why the contingency notification may be such an important feature of the whole system.

At a glance, additional customers will be able to see predicted to be most important e.g. it does it affect the securities that they all out contracted for, considering that there are no indicators or operators to understand. In general, factors are selected for inclusion in particular applications and generally consist of financial instruments that as determined, have a relationship directly and indirectly to the price action of the instruments. These relationships may be measured as either negative or positive correlations which may make up the optional third part of the array of information. Any valid relationships and appendices, including those that are not here, will be detected in use by the system to learning mechanisms contributing to the accuracy of each prediction task. New relationships will be constantly forming.

Other embodiments of the present invention include a risk profile adjustment feature which would allow the user to determine their own risk profile. In a preferred embodiment, there would three categories of risk: low, medium and high, but other types of organization could also be used. Each level would have an automatically triggered stop-loss or take-profit associated with it. For example, a high risk profile client would set their take-profit trigger at 100% of our predicted magnitude and set their stop-loss trigger at, for instance, a decline of 50% of our predicted movement. A medium risk profile would take profit at 75% of our forecast move and their stop-loss at a decline of 30% of our forecast. A low-risk profile would, in a typical scenario, set an end-user's take-profit level at 50% of our forecast and the stop-loss at a 15% decline point. In addition to the pre-set profiles, each brokerage firm could choose to let their set their specific levels, outside of the “canned” versions. All of these levels could be accompanied by “rolling” stop-losses and take-profits which would move up or down in accordance with the price movement of the particular stock. In other words, the user could determine to take no profit at our forecasted level, expecting the stock to move even further (up or down). Simultaneously, the stop-loss levels would move upward or downward in proportion to the actual price movement. This feature, which is often called, “tightening the stops,” and is currently available, but has not been available in conjunction with the scientifically generated suggested take-profit or stop-loss of particular embodiments of the present invention.

The present invention has the ability to allow a trader to “auto-populate” the trade execution screen based on forecasts. The real time input required for the “stock market specific” version of the product incorporates many other asset classes, as the futures and even options that are at the root of the markets make the best indicators of change for the project. The invention also includes the novel presentation or view of the product as a redirection engine that incorporates real time input and is capable, with different sets of input information, of price and direction, buy, sell, hold, and confidence in a great many asset classes, but as can be appreciated by those skilled in the art, the invention is not limited to foreign exchange, fixed income, futures and options.

The applicant invention can place intelligent “two-tier based agents” also referred to as advisors to capture and model dynamic changes in information at run time. Technical Analysis: this rule assumes that stock prices are not random walks and that past trading behavior will provide enough information for future price behavior.

The invention may include one or more super advisor(s), who is an integral part of the system architecture, a meta-advisor or high-level advisor or a contrary advisor which always bets against it.

The Optional Overlay advisors include the surprise overlay advisor which annihilate the difference between actual close and predicted close. Momentum overlay advisor read the total change in the last ATL day's and analysis prediction in overlay advisor which read the signals from mid-level pattern analysis advisors to approximate the population is a trader is correlated with fouling and or fading them. Buying Pressure Overlay Advisor proprietary Spectrum indicator adjusts for trading versus chomping movements. PIVOT point overlay advisor proprietary daytrading system relates to distance from three-day pivot points.

The base advisors B-AD are generally a collection of machine learning systems and can be implemented for other applications outside of financial market theories. The advisors process specified factors, indicators and trading systems that are reflective of specialized criteria of the present application. All of the advisors review raw times series data with the base advisors and also review the output of the indicators, process raw data. The opinions of each of the advisor is reviewed by the super advisor using machine learning for what is termed in the present invention as a consensus. Resulting predictions are compared against actual price activity and advisors are rewarded or punished according to the accuracy of the contribution to the consensus.

Another example is the nearest neighbor advisor which finds the historical precedent and best matches the current situation and reason of my analogy with that situation in to make the decision. The decision tree advisor: the present invention uses the decision tree which explains 90% of past price movement as a function of the operators. The decision tree represents patterns that predict the past. In security, the decision tree advisor uses the current decision tree to make its forecast for that security. The Joe Advisor is a daytrading system developed by Joe D. Napoli in the book trading with the within “Dinapoli” levels. The FIBO advisor is a system that combine this neural net with a traditional Fibonacci retracement analysis. The Equity trading advisor equity daytrading is a study that uses all current coated indicated years with a proprietary scoring system. Mutual fund trading advisor uses a proprietary mutual fund daytrading system.

Each of the base-level advisors B-AD, is part of a reward and punishment system. In this context as described above, rewarded and punished are terms that are indicative of the importance the advisors are given subsequently.

### Other Embodiments

In another embodiment, for high wealth but less active clients, the invention allows transmission for end-of-day forecasts along with the account summary sent out to Schwab's clients nightly. This would allow the investors to review their holdings nightly (as about 85% of individual investors do, according to several studies). They can also make decisions about their actions for the next day, based in part on our forecasts for their specific holdings, and input trade orders that night, to be executed at the open of the market the next day. They would also have the ability to require a specific price for their orders, if they preferred a limit order to a market order.

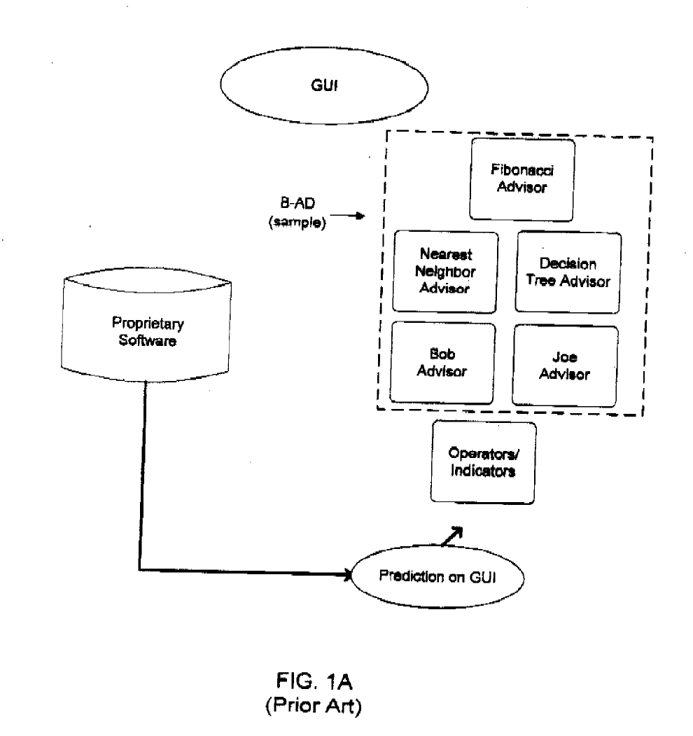

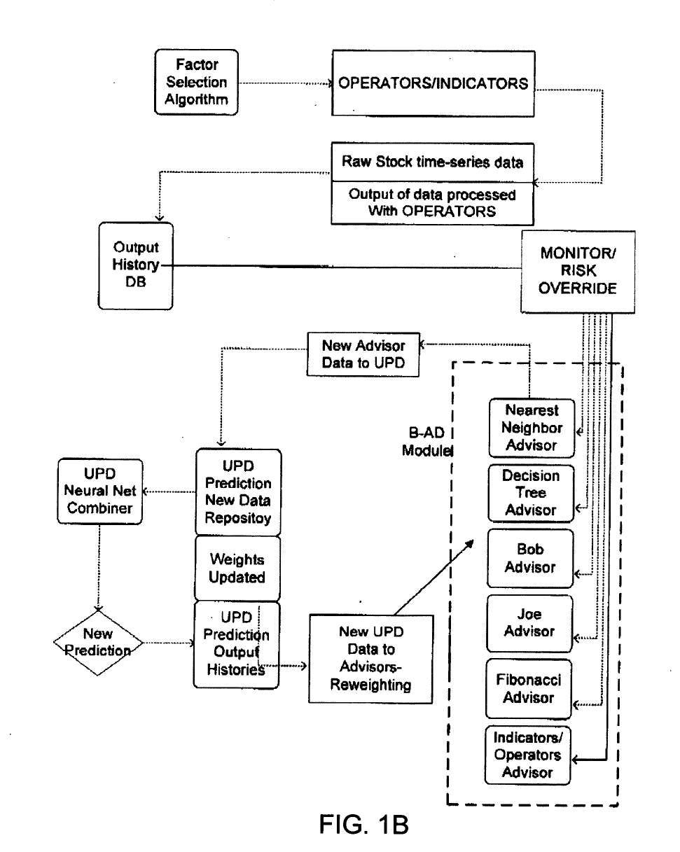

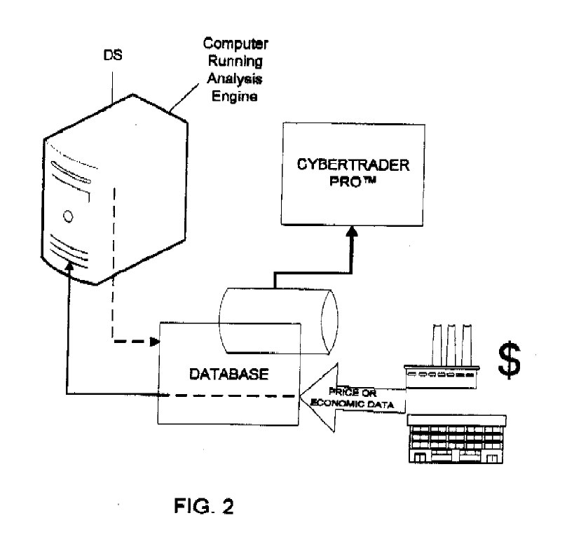

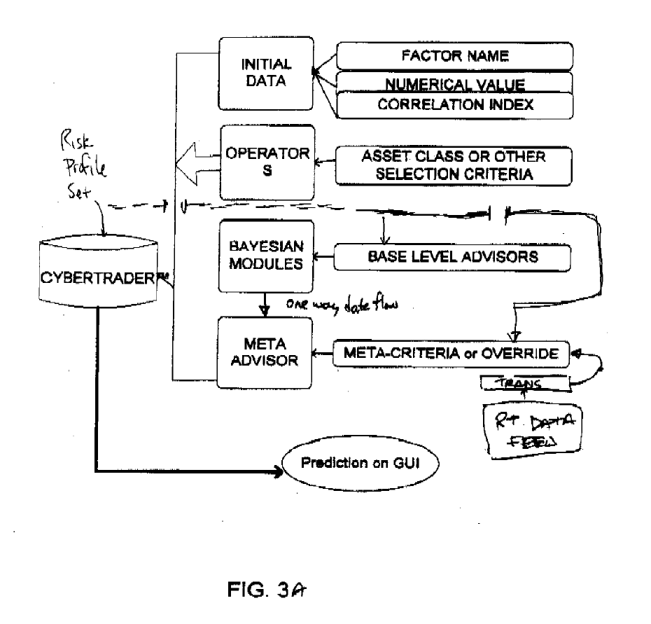

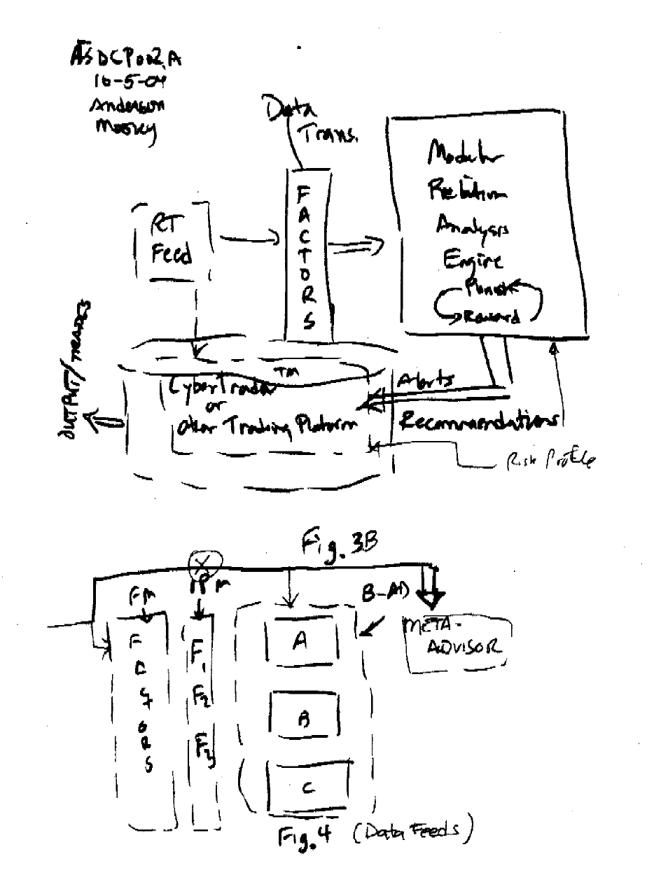

In FIG. 2, four representative insertion points show how the invention works with proprietary software unrelated to the present invention. The insertion points are critical in that they provide the “engine” described above with the fuel to allow effective predictions and loss prevention. Six sample advisors are shown in FIG. 1, but as described below and shown in FIG. 11 many other types of advisors can be implemented.

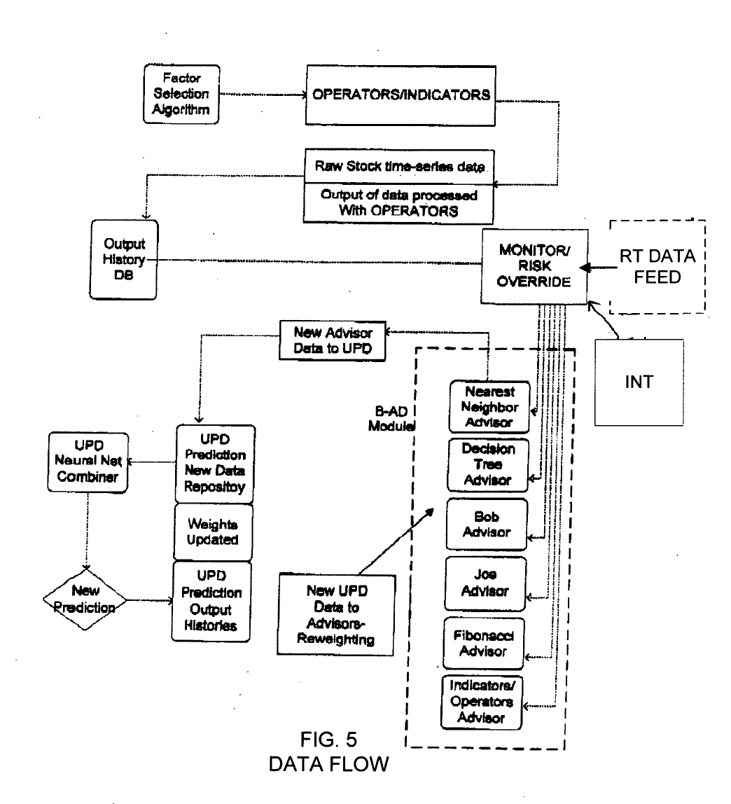

Referring now to FIGS. 6A and 6B, a sample output series of display screens is shown, although the invention is not limited to any particular type of output, these screenshots illustrate some of the relevant features. For example, in many embodiments the confidence statistic or results in this an important part of the commercial desirability. Confidence can be measured along several different lines as having described below.

The present invention in a preferred embodiment includes several types of confidence level output which is shown in FIGS. 6A and B. For example, confidence level-A is a normalized scale from 1-10 that indicates the predicted movement of a commodity and/or equity. Another type of confidence level-M, which is confidence in the change of the magnitude is also normalized on a Scale 1-10 (but not shown in FIGS. 6A and B).

Below, a sample data output, labeled as “output 1” and not necessarily related to FIG. shows the operational features of the present invention. Those skilled in the art will appreciate that this data is representative of some of the capacities of the present invention but should in no way be limited to the data represented below. More output examples are included in Appendix B.

Output 1

“Ordered Trades (long and short):”

((NVDA −0.59 0.58055854 10) (BBH −2.3899999 1.5906973 10) (DCGN −0.28 0.48265606 10) (IWM −0.9 1.3383011 10) (MER −0.7 0.7508018 10) (DELL −0.53 0.51756924 10) (IBM −0.64 0.9412986 10) (RJR 0.68 0.7078549 10) (ET −0.26999998 0.2892276 10) (EBAY −1.38 1.1716574 8) (EK 0.31 0.5306482 7) (DIA −0.65 0.71167386 5) (CSCO −0.35 0.52063775 5) (PMCS −0.42999998 0.64616877 4) (EMC 0.29 0.28052995 4) (NT −0.22 0.27010044 3) (JNJ −0.42999998 0.46970314 3) (GS −1.25 1.2996379 3) (MO −0.34 0.5604123 3) (LUV −0.21 0.30833358 3) (AMTD 0.35999998 0.42054433 3) (TRAD −0.14 0.26685566 3) (IVGN −1.02 1.2453798 3) (MACR −0.29999998 0.49272728 2) (ORCL −0.19 0.22886491 2) (RFMD −0.17 0.3745882 2) (AMZN −1.29 1.235272 2) (GE 0.21 0.3864143 2) (MSFT −0.24 0.27343392 2) (EWJ 0.08 0.12692635 2) (GM 0.48999998 0.6990766 2) (SPY −0.96 0.79854697 2) (QQQ −0.64 0.41694745 2) (MWD −0.61 0.82731 616 2) (BAC 0.68 0.6573803 2) (AXP 0.32999998 0.5093239 2) (WMT 0.59 0.67492133 2) (PFE −0.28 0.4087835 1) (SLR 0.17999999 0.21089374 1) (INTC −0.38 0.55482894 1) (BRCM 1.0 1.0360907 1) (MMM −0.82 1.0477368 1) (AMGN −0.84999996 0.85093194 1) (AGRA 0.089999996 0.1353456 1) (JDSU −0.08 0.15793625 1) (AMR 0.44 0.4752189 1) (F −0.19999999 0.3006487 1) (RIMM 2.11 3.1781144 1) (LU 0.099999994 0.12505732 1) (JNPR −0.71999997 0.97768885 1))

“Long Trades:”

((RJR 0.68 0.7078549 10) (EK 0.31 0.5306482 7) (EMC 0.29 0.28052995 4) (AMTD 0.35999998 0.42054433 3) (GE 0.21 0.3864143 2) (EWJ 0.08 0.12692635 2) (GM 0.48999998 0.6990766 2) (BAC 0.68 0.6573803 2) (AXP 0.32999998 0.5093239 2) (WMT 0.59 0.67492133 2) (SLR 0.17999999 0.21089374 1) (BRCM 1.0 1.0360907 1) (AGRA 0.089999996 0.1353456 1) (AMR 0.44 0.4752189 1) (RIMM 2.11 3.1781144 1) (LU 0.099999994 0.12505732 1))

“Short Trades:”

((NVDA −0.59 0.58055854 10) (BBH −2.3899999 1.5906973 10) (DCGN −0.28 0.48265606 10) (IWM −0.9 1.3383011 10) (MER −0.7 0.7508018 10) (DELL −0.53 0.51756924 10) (IBM −0.64 0.9412986 10) (ET −0.26999998 0.2892276 10) (EBAY −1.38 1.1716574 8) (DIA −0.65 0.71167386 5) (CSCO −0.35 0.52063775 5) (PMCS −0.42999998 0.64616877 4) (NT −0.22 0.27010044 3) (JNJ −0.42999998 0.46970314 3) (GS −1.25 1.2996379 3) (MO −0.34 0.5604123 3) (LUV −0.21 0.30833358 3) (TRAD −0.14 0.26685566 3) (IVGN −1.02 1.2453798 3) (MACR −0.29999998 0.49272728 2) (ORCL −0.19 0.22886491 2) (RFMD −0.17 0.3745882 2) (AMZN −1.29 1.235272 2) (MSFT −0.24 0.27343392 2) (SPY −0.96 0.79854697 2) (QQQ −0.64 0.41694745 2) (MWD −0.61 0.82731 616 2) (PFE −0.28 0.4087835 1) (INTC −0.38 0.55482894 1) (MMM −0.82 1.0477368 1) (AMGN −0.84999996 0.85093194 1) (JDSU −0.08 0.15793625 1) (F −0.19999999 0.3006487 1) (JNPR −0.71999997 0.97768885 1))

“Factor Forecasts:”

(($OEX −3.76 3.9945574 10) (C 0.32 0.4668479 10) (JPM −0.53 0.3887561 6 10) ($IXF 14.639999 45.875294 10) ($OIX −2.87 2.9445841 10) (DNA −2.1399999 1.5705947 10) (AA 0.53 0.69572103 10) (HD 0.31 0.4644559 9) ($PSE −8.51 8.228567 9) (CY −0.29999998 0.44947505 9) ($TRIT −0.53999996 0.8132198 9) ($XAU 2.3799999 2.0512803 9) ($XMI −4.64 6.8969135 8) (MRK −0.35 0.6085382 8) ($MOX −0.19 0.20609091 8) ($VIX 0.68 0.9032603 8) ($TYX 0.29 0.47938484 8) ($IXCO −8.87 13.455776 8) ($NDX 12.309999 17.681053 7) (KLAC −0.71999997 1.0593249 6) ($SOX 7.7999997 9.652003 6) (HPQ −0.32 0.42573407 6) ($RUT −5.0699997 6.683315 6) ($SPX 4.7999997 7.992286 6) ($RUI 2.59 4.2506285 6) (CAT −1.12 1.188255 6) ($TRIN −0.57 0.6360811 5) (DD −0.41 0.49481577 5) ($OFIN 32.07 41.15187 5) ($MSH −6.89 6.61 81483 4) (XOM −0.32999998 0.39069107 3) (AMD −0.44 0.43208045 3) ($SXV 0.52 0.81607336 3) (NOK −0.26 0.5869697 1) (SCH 0.19999999 0.23420261 1) ($OSX 1.4499999 1.5517198 1) ($BKX 72.85 90.33106 1))

“TOP 10 Indicators [Operators] Used: “((” facilitation streak”. 6.207102) (“weird trader's formula”. 6.1357546) (“Standard Deviation of change”. 5.7111616) (“Joe predictor”. 5.4989996) (“last change”. 5.340061) (“Inside bar”. 5.141086) (“trend clock”. 4.8336005) (“Fidelity indicator”. 4.804117) (“decision tree advisor”. 4.5749583)(“break direction”. 4.544185))

(“produced by STOCKO on” “Apr. 7, 2004” “at” “13:07:29”)

In a first embodiment the invention, a computer-implemented method is used for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Bayesian-logic functions, each with a corresponding adjustable weights; determining a recommendation for the equity based on the above-described Baesyian logic analysis, and reporting the recommendation to a user as output; comparing an actual result for the equity to the recommendation, and adjusting at least one of the Bayesian logic functions or modules corresponding weights for any future recommendation (punishment/reward); and the invention includes setting an adjustable risk profile for an equity trade.

The adjustable risk profile system allows for the selection of the risk profile analysis, in which a user can choose between pre-defined risk profiles and manually set ones. Of course, as can be appreciated by the those skilled in the art, different risk profiles can be set to account for different parameters or circumstances, which may be automatically provided or monitored by certain embodiments of the invention.

Optional features include: the content of the output further includes using actual dollar prices; the output includes forecasting a specific price movement for each stock; and the output includes with direction of movement, magnitude of movement, and confidence of movement.

Other optional feature includes where the equity trade is not recommended unless said confidence level is above a user-specified target. The equity trade cannot be placed unless said confidence level is above a target level, or the confidence data is normalized, such that it is scaled from 1 to 10 as output. Other optional features include a third-party trading system capable of performing rolling-stop losses.

In another embodiment discussed more at length in co-pending U.S. application Ser. No. 10/711,128, and incorporated by reference, the invention uses a computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Bayesian-logic functions, each with a corresponding adjustable weights; determining a recommendation for said equity based on said Baesyian logic analysis and reporting said recommendation to a user as output; and comparing an actual result for said equity to said recommendation and adjusting at least one of said Bayesian logic function corresponding weights for any future recommendation, wherein the invention includes using interest rate data for said stored data arrays.

In a third embodiment the invention, a computer-implemented method is used for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Bayesian-logic functions, each with a corresponding adjustable weights; determining a recommendation for said equity based on said Bayesian logic analysis and reporting said recommendation to a user as output; comparing an actual result for said equity to said recommendation and adjusting at least one of said Bayesian logic function corresponding weights for any future recommendation, wherein the invention includes setting an adjustable risk profile for at least one equity trader and publishing stop-loss and take-profit levels generated by executable instructions.

Other variations of the invention include where the output ranks multiple equities by confidence level, both on the buy side and on the sell side. The output includes with direction of movement, magnitude of movement and confidence of movement. The equity trade is not recommended unless said confidence level is above a user-specified target; the equity trade cannot be placed unless said confidence level is above a target level, the confidence data is normalized, such that it appears scaled from 1 to 10 on said output. The set of arrays include data relating to interest rates, and the set of arrays include data relating to foreign equity markets.

The output ranked the stocks by confidence level, both on the buy side and on the sell side. In addition to the price movement forecasts, the present invention improves on the experimental artificial intelligence platform through the “publishing” of the scientifically generated stop-loss and take-profit levels. This was a huge improvement over the rather casual and unscientific techniques employed by most day traders up unto that time. From the brokerage firm's perspective, this was a great enhancement in that it increased the odds of their clients remaining solvent, thereby increasing the life and activity of the account. Our stop loss and take profit levels were also adjustable to accommodate the particular client's risk preference. More detail is provided on this feature and its value in the original document.

The data is moved from the third party proprietary software backend to a base-level prediction system connected seriously base-level advisors. Although only six advisors are shown in the diagram, as can be appreciated by those skilled in the art, different types and configurations of advisors at the base-level can be included in different environments of the invention.

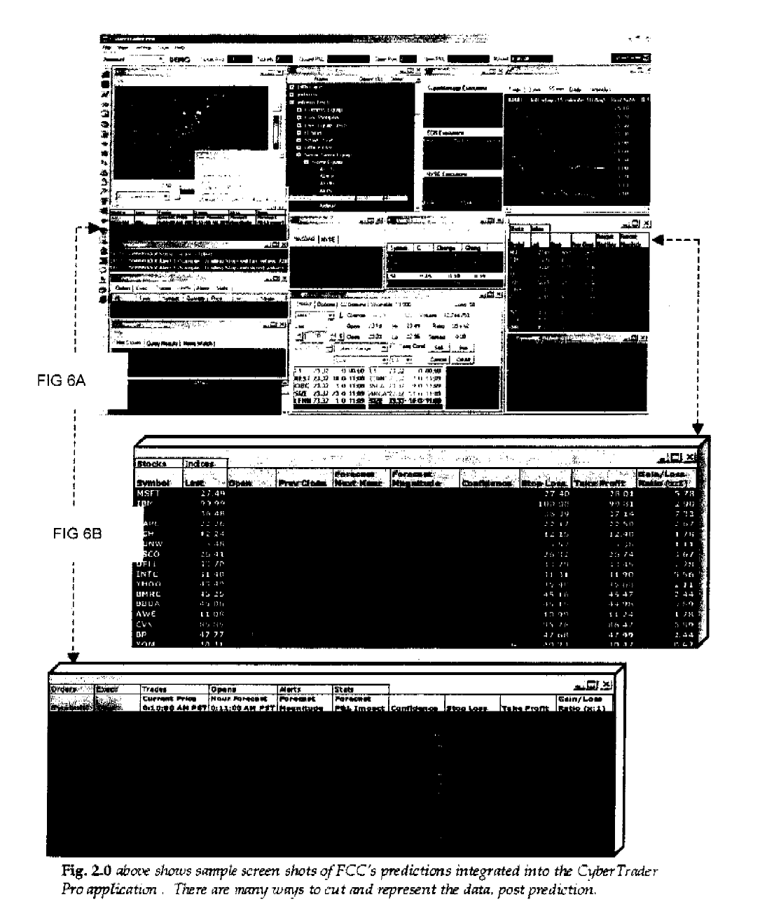

FIG. 7 shows an embodiment of the invention in which the real-time data feed is used or “intersticed” into the neural analysis engine, such that it can adjust the trading recommendation based on a number of factors and virtual configurations. As can be appreciated by those skilled in the art, the real-time feed and override/adjustment system can operate either internally or externally to the neural analysis engine discussed in the background to the application. While some situations would indicate that computing power would economized by building in these features, other computing environments would benefit from externally controlled, either from another computer or monitoring program.

In FIG. 7, a monitor layer ML, has the ability to bypass either separately or in conjunction with the Bayesian layer B-AD to inform the trader that the user set risk level or other parameter (factor, relation, etc, as will be discussed below) or condition has been met based on the real-time data feed or other data. Thus, the ML bypasses the meta-advisors to let the trader know that said condition exists, or rather that a trade should be made based on the risk profile.

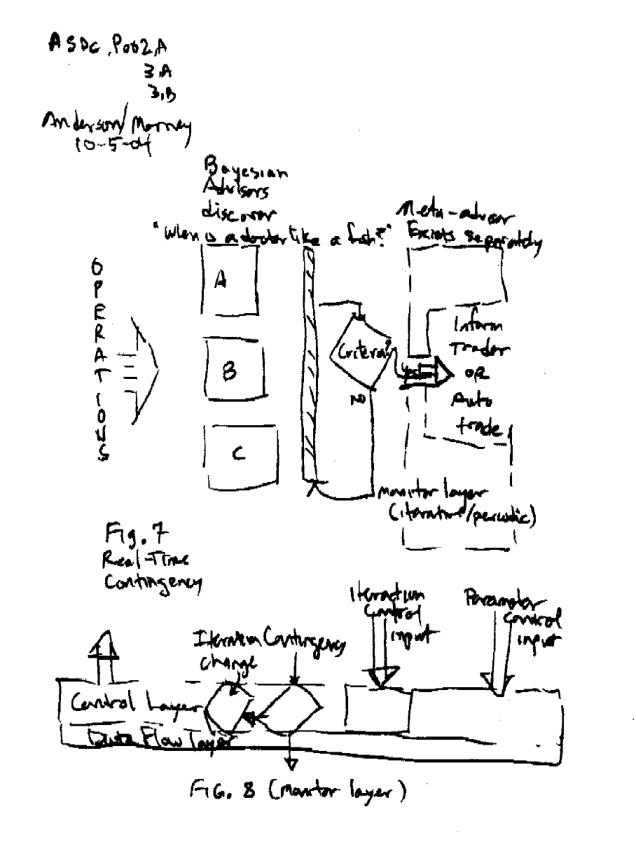

FIG. 8 shows the representative functions of the external or internal monitor layer ML. The parameter control input may accept real-time data directly from a feed that is also supplied to CYBERTRADER™ or other trading program. The parameter control input may accept several layers of direct or “interpreted” data, such as factor/arrays or from the Bayesian advisors or a combination of such advisors. The interaction control input acts a “data traffic cop” between all the layers or data the layer must manage. Thus, this layer is particularly effective when running on the same computer or processor as the neural analysis engine, but is architecturally separated from the engine. Thus, the monitor layer ML can have the level of complexity desired by the end-user without necessarily interfering with the neural analysis engine.

The contingency module shown in the monitor layer, is simply the criteria to either continue as normal or inter alia, notify the trader that a condition or risk profile condition has been met or that another factor leading to the immediate recommendation that a trade be executed (or optionally providing instructions to execute the trade automatically). If conditions do not merit the immediate contingency bypass, the situation is analyzed for “iteration” adjustment. Iteration adjustment is one of the computation control mechanisms that may respond to real-time data either directly on through interpretation. Other internal operations of the neural analysis engine may also be adjusted, although too much control from external data may interfere with the machine learning process and the scalable nature of iteration makes is less likely that the neural processes will be disturbed simply by asking them to perform their relationship determinations (“why is a doctor like a fish?”) more frequently. The control of the processes may be adjusted through instructions provided by the monitor layer ML.

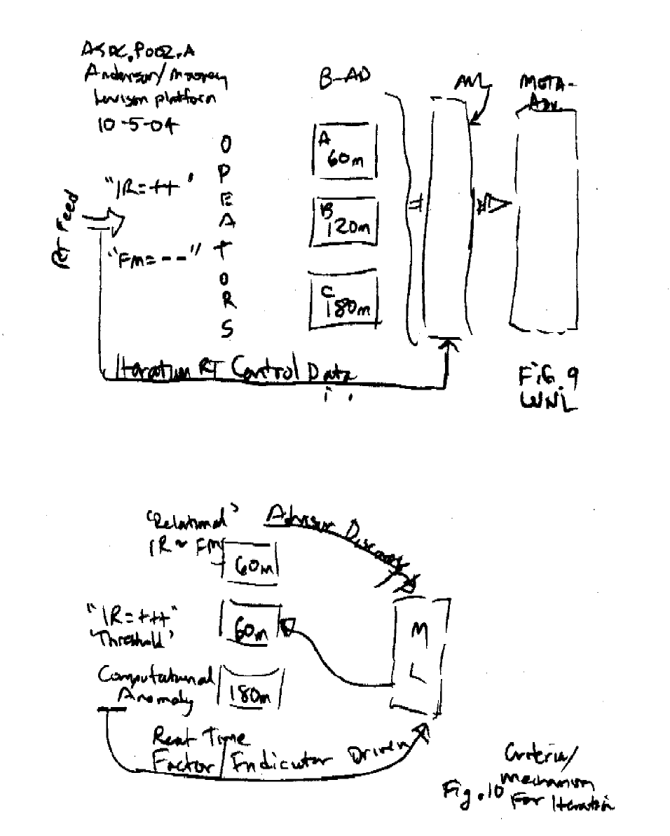

Referring now to FIG. 9, a real-time data feed is fed into the monitor layer ML directly from the factors or data arrays for iteration control purposes.

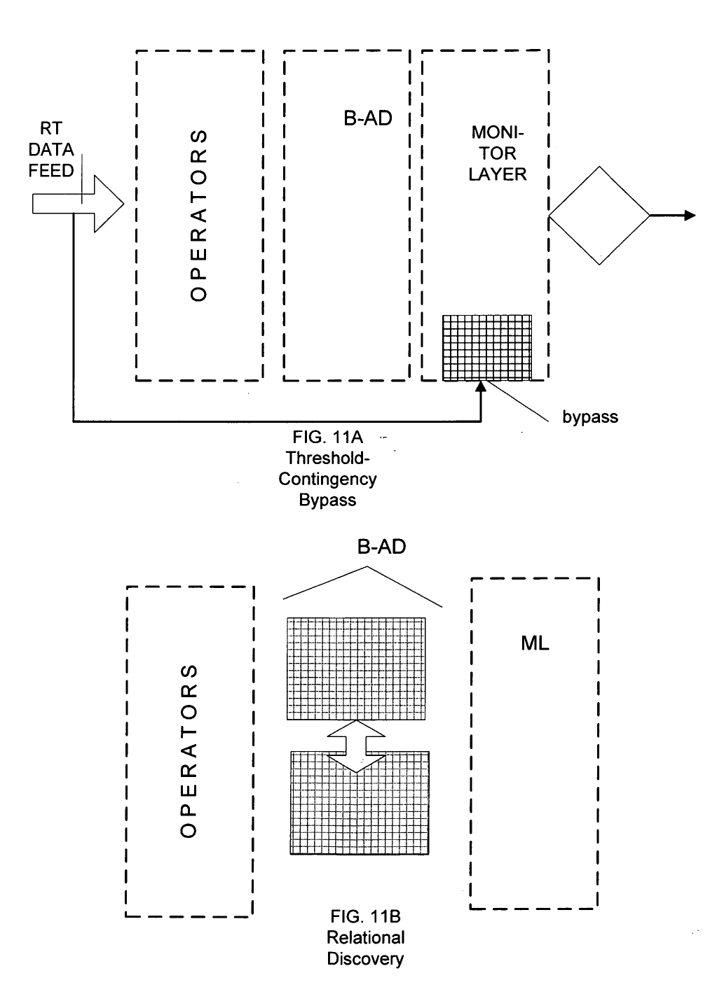

FIG. 10 shows an iteration adjustment from the system as shown in FIG. 9 for the Baeysian logic module B-AD. The B advisor changes it monitoring from 120 mins to 60 mins based on a real-time factor condition (shown as “IR=+++” which may stand for interest rates have risen at an unexpected rate) shown by the bottom data flow arrow. The interaction change may also have resulted from a “discovery” by the logic module B-AD of a new relationship or cautionary situation (shown as IR˜FM, or an approximate direct and proportional correlation) which is indicated by the top data flow arrow. Other items that could result in iteration control of one or more individual modules in the Baeysian logic module B-AD are discussed below in FIGS. 11A-D, but are not limited to such conditions.

Unlimited computational power would affect the need to continually perform the neural analysis and may eventually allow certain advisors to run continually. However, there is also a risk that the discovery of certain relationships may actually be destroyed by setting the interval to small.

FIGS. 11A-11D proposed some possible relationships or determinations that would lead to an override situation, but are also applicable to the iteration control discussed in FIGS. 9 and 10 above. FIG. 11A simply shows that a factor in the data array provides a piece of data in the monitor layer that leads to a contingency implementation for trade notification or other scenario. Needless to say, the by-pass based on a singular factor is not meant to replace the operation of the neural analysis engine, but is meant to set forth only in the most serious of conditions or based on a particular factor in the risk profile. FIG. 11B shows a system in which a contingency by-pass may also be developed from a “discovered relationship” between a couple of neural modules in the Baeysian logic module B-AD.

FIG. 11C shows that a “no confidence” or undefined parameter may also trigger a by-pass situations. This particular aspect is more complex because there are an infinite amount of undefined relations that can be created though machine learning. However, it may useful to consider key undefined parameters from the operations as an operator that flags a particularly unusual anomaly is communicating that the normal mathematical operations are not useful in the present situation related to the data feed. Optionally, as shown in FIG. 11D a particular Baeysian null set or lack of information (“misfire”) may provide the by-pass or optionally, iterative adjustment discussed above. The iterative adjustment (or the by-pass) may be provided by a signal from an external computer.

The quality of the present invention is partially dependent on the quality of the input. Choosing from a large number of more specifically targeted inputs to populate the parameters which include the factors and the set of operators that will be used. The major obstacle was that there literally tens of thousands of possible candidates for inclusion in the model. The present inventions obtain a complete global data set for research. In particular embodiments, the initial data set is chosen from those data items the ones best suited for the general stock forecasting needs, as opposed to being limited to mutual funds or other items. The inputs most closely correlated to the expected price movement of the basket stocks. These inputs consisted of other stocks in the same industry as some of our target stocks, market indices, sector indices (such as SOX) certain commodity prices and fixed income futures prices.

For example, as may be appreciated by those skilled in the art, interest rates, and interest expectations, drive all financial markets. Therefore there must be a connection to interest rates included among the factors. They also “lead” the markets temporally, thus acting as an “early warning” or leading indicator of market moves that are about to occur. Certain interest rate securities or derivatives reflect the current demand for borrowing and the relationship of that demand to the currently available supply of money for lending. Other interest rate securities and derivatives are more useful in determining the market participants' expectations of interest rate movement, and the possible magnitude of that movement, in the future.

The day-traders who evaluated this feature felt that they could make sufficient profit by trading those stocks with the highest confidence level, such enhancements to the outputs appear to be a major advancement for successful marketing of the invention in some of its embodiments. Output is particularly important for the contingent notification embodiments of the invention, which further enhance opportunity and/or reduce risk.

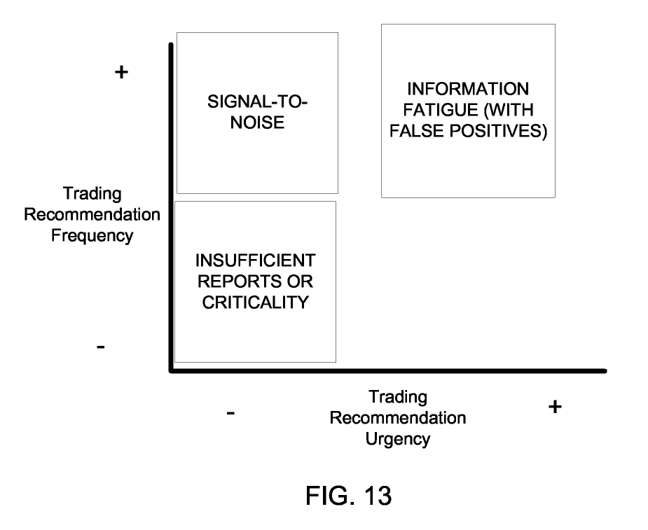

Output that is simply “continuous” may not provide the identification relevant information that must be brought to the attention of the trader, as well as being a drain of computing resources. The particular embodiments of the invention must account for “information fatigue” or “information overload” in which that key elements that are generated from the monitoring of the real-time or near real-time data feed, such that contingent trading provided by the embodiments of the invention are not fictitious. This is illustrated by FIG. 13 in which it is desirable to attain the required level of output while providing sufficient contingency notices that a factor or neural relationship has reached a target level that may be universal or particular to that system.

A single forecast for each day is generally not generate forecasting information draw enough added trading volume to make commercial embodiments of the invention attractive to the brokerage houses, which would use the invention to increase volume and profit. The strategy developed was to license the product to major large electronic brokerage firms, and other large vendors of raw price data for them to, in turn, provide the inventive product to the client base of the large brokerage houses and “pay” accordingly. It was commonly thought that commercial versions of the invention would best be licensed by simply creating a website and charging users on a “per hit” basis. The real monetary reward was to come from the re-distributors as they saw the commercial embodiments of the invention first as a competitive advantage and later as a “must have” item to match the competition.

Appendix A

CyberTrader

CyberTrader's Direct Access order routing technology adds two weapons to the Active Trader's arsenal: Control and neutrality. Through CyberTrader, Direct Access to the market participants of your choice ensures that your order doesn't disappear into the void—you know where it's being routed and why.

Available venues and order types include:

Smart orders are available for both equities and options on Limit and Market order types. Smart orders work from a “snapshot” of the market at the moment you enter the order. They look at which market participants/exchanges are available at that instant, rank them, and try to get you the best match all the way up to your limit price (if there is one) based on that ranking.

CyberXchange™ can execute Limit, Market, ECN, Stop, Stop Limit, and Trailing Stop Loss order types for Day, Good 'Til Cancel (GTC), and Time in Force conditions. CyberXchange will assume the availability of Reserve Shares for certain counterparties (the assumed reserve amount varies depending on the counterparty) and will send your sub-order with a higher quantity than the counterparty is displaying with the hope of filling your order more quickly and/or at a more favorable price. (ECNs, Market Makers, and exchanges often do not display on Level II the full quantity of shares they have available, but will instead post a certain number of shares and hold the rest back in “Reserve”.) Additionally, CyberXchange now has shortened timeout settings for sub-orders to keep your order from stalling with a particular counterparty if they do not have the assume reserves available to fill the order.

Direct ECN access gives you speed and control, allowing you to send orders straight from CyberTrader to Archipelago (ARCA), Attain (ATTN), Brut (BRUT), Bloomberg Tradebook (BTRD), INET, and NexTrade (NTRD), without using additional intermediate routing systems. On CyberXchange orders, CyberTraders can use the ECN-only option, to send orders only to ECNs with which CyberTrader has Direct Access, increasing the likelihood of a speedy and optimal execution.

SuperMontage^{SM} and SuperMontage Directed are Nasdaq systems that route orders to market makers and participating ECNs. With SuperMontage, you can route orders directly from CyberTrader to specific market participants or to all SuperMontage participants by sending a broadcast order. You can also route orders for dual listed securities (NYSE/AMEX and Nasdaq) to the SuperMontage venue. This capability gives you access to Nasdaq's electronic order execution system and liquidity, possibly improving order execution speed.

SCHB order routing through Schwab allows you to trade Over the Counter (OTC) and OTC Bulletin Board stocks. The SCHB venue helps manage your risk exposure by using the GTC, Time in Force, and Stop Limit conditions on Nasdaq stocks.

AMEX order routing is also available through Schwab. This venue allows you to send Stop, Stop Limit, Limit on Close (CLO), and other order types on AMEX Listed and Nasdaq stocks.

NYSE is available for all NYSE Listed orders. CyberTrader routes orders to the NYSE through Schwab. You can also route orders for dual listed securities (NYSE/AMEX and Nasdaq) to the SuperMontage venue. This capability gives you access to Nasdaq's electronic order execution system and liquidity, possibly improving order execution speed.

CME and CyberXchange are available order routing venues for futures trading.

Below is a table of all order routing choices for CyberTrader Pro Equities traders.

Trade Stocks

The Stock Box is CyberTrader Pro's primary order routing and intraday data interface. Minimizing the time between decision and action can be crucial. As such, the Stock Box was carefully designed to put the most important information at your fingertips to help you act on a security's most relevant, up to date data.

Enter a stock symbol and the Stock Box is populated with:

16 fields of real-time vitals for the stock, including open/close figures, Level I bid/ask ratio, volume, high/low, and the spread to keep you informed about the latest movements of the stock as you make trading decisions. The Stock Box also displays the number of shortable shares available and has a feature that allows you to quickly estimate the number of shares you can trade for a specified dollar amount.

Level I, Level II (Total View™), and time & sales data, and ECN books from ARCA, BRUT, and INET give you a full view of market depth in the stock by showing posted bids and offers at every price level and the number of shares each posted by each participant. You can display the status, time, and directional change of each posting quote. Additionally, set your window to highlight certain participants within Level II (such as all ECNs or particular Market Makers);

Order routing venues available for stock include the ability to add special order conditions such as pegging, invisible orders, Immediate or Cancel, All or None, etc.

Trade Options

Derivatives like options provide you with an opportunity to capitalize on market fluctuations using strategies not available when trading stocks. CyberTrader Pro offers advanced tools that can help you make the most of your options trading strategies. If you are approved to trade options, you can click on the Options, Level II Options, and Advanced Options tabs in the Stock Box to view:

Options Greeks may help you determine data points to measure an option's potential value and pricing in various contexts; time, fluctuating value of the underlying stock, and more. The following three options pricing formulas are available: Black-Scholes, Cox-Ross-Rubenstein, and Barone-Adesi-Whaley. With Options Greeks, you may be able to further determine how to hedge your portfolio and evaluate the performance of options contracts.

Options Chains display calls and/or puts up to more than two years forward, including strike price, symbol, last trade, change from close, current bid/ask, volume, and open interest. Up and down ticks in bid or ask are easily identified by color, red or green. “At the Money” contracts automatically highlight to give you a common reference point of market performance when viewing options chains.

Options Level II includes open interest; total volume; volume by exchange; bid/ask prices; size on each exchange; and time and sales data. Options Level II data provides you with a greater depth of information about the options contract being viewed. The number of contracts at specific bid/ask prices and time and venue of the last sale are shown to help determine the market's momentum. Available options order routing venues are: American Stock Exchange (AMEX), Boston Options Exchange (BOX), Chicago Board Options Exchange (CBOE), International Securities Exchange (ISE), Pacific Exchange (PCX), and Philadelphia Stock Exchange (PHLX).

Advanced Options order entry choices use common options pairing strategies designed to help you determine how to hedge your portfolio. Strategies available are: Buy/Write and Unwind, Straddle, Rollout, Calendar Spread, Vertical Spread, and Collar. Through CyberTrader, you also get Direct Access to the ISE and CBOE for your complex options orders. This helps you avoid the possible market risk of legging in and you only pay 1 base commission per each pair of legs, plus a per contract fee. Armed with a variety of strategies to choose from, you can take advantage of trading opportunities that might otherwise be missed.

Options trades can be initiated from all Options tabs in the Stock Box ensuring your ability to place trades as soon as you make trading decisions.

Right-clicking on an options symbol in any of the three tabbed windows allows you to access:

Advanced data for the option, such as the multiplier, size, tick direction, exchanges trading the option, etc.

Hypothetical Pricing based on Black-Scholes, Barone-Adesi-Whaley, or Cox-Ross-Rubinstein pricing methods. The strike price, share price, expiration, volatility, interest rate, and/or dividend yield can be modified to calculate hypothetical option prices and Greek values based on potential market fluctuations.

Note: Commissions, taxes, and transaction costs can be a significant factor when implementing any options strategy. Multiple leg strategies involve multiple commission charges. For more details on standard option or multiple-leg option commissions please visit our Commission and Fees section at http://www.cybertrader.com/fees. Contact a tax advisor for the tax implications involved in these strategies. Options carry a high level of risk and are not suitable for all investors. Certain requirements must be met to trade options through CyberTrader. All accounts are accepted solely at the discretion of CyberTrader, Inc. Please read the Options Disclosure Document titled Characteristics and Risks of Standardized Options before considering any options transactions. Copies of this document are available by calling (888) 762-9237 and selecting prompt “1” and then prompt “1” followed by “2”, going to http://www.cybertrader.com/forms/OCC Disclosure.pdf for an electronic copy, or by writing CyberTrader, Inc., PO Box 202890, Austin, Tex. 78720. Member NASD/SIPC.

Trade Futures

CyberTrader Pro is known as a leading trading platform for trading equities, options, and futures. Once you have opened a dedicated futures trading account, you can log into both your equities/options accounts and your futures account and toggle between both with a click of the mouse. For the demanding futures trader, CyberTrader Pro provides powerful execution capabilities, account management, and a range of analytical tools.

After typing a futures symbol, the stock tab becomes the futures tab and clients can:

Buy and sell the following futures E-mini products: S&P 500™, Nasdaq 100, Russell 2000®, and S&P Midcap 400™.

Close a futures position and establish a new position with the same number of contracts in the opposite direction in one step with the new Reverse action button.

View Level 11 CME Futures* data, which displays bid/ask prices and quantities up to five levels.

CyberTrader Pro provides futures traders with more than just execution functionality. Clients can take advantage of the alerts system to find opportunities, and the full charting package to evaluate and analyze both specific futures securities and the full derivatives market. In fact, many of the tools that are available for equities and options trading can be used for futures trading.

et the Big Picture

The Stock Box is more than a tool that allows you to place trades and view data; it can be linked to other windows in the software so that when you load a symbol into the Stock Box, it can immediately load the symbol into some or all of the following CyberTrader Pro tools:

News—Instantly runs a query for news on the symbol and displays the results in the Query Results tab. Includes the latest news coming from Dow Jones Newswire™ that could affect the stock.

Dynamic Ticker—Begins tracking the stock's tick direction, quote changes, quantity changes, and other parameters to give you a sense of the momentum in a stock.

CyberCharts—Display the price chart and any technical studies you have set up for the loaded stock. Depending on the charts your Stock Box is linked to, you can see the intraday movements of the stock or see how the stock has behaved over the long term. With CyberTrader Pro, you can use up to 20 chart windows at once.

Hammer—Helps you identify the most active Market Makers or ECNs in a stock by tracking how many times the market participant has refreshed their quote at the inside bid or ask.

ECN Book—Displays ARCA, BRUT and INET ECN book data (bid, ask, quantity, time & sales) for the loaded security. The ECN book can give you a quick picture of the overall liquidity in at each tier, or show you how much interest from individual participants there is at a particular price level.

Tailor Your Trading Experience

Because no single trader's needs exactly match those of another trader, CyberTrader Pro provides a variety of order routing customization features, including the ability to:

Verify orders before they are sent, as well as enable or disable keyboard executions (helps prevent placing orders inadvertently),

Specify a Delta Value, which can be used when trading listed stocks or when using SuperMontage Directed as your order venue when trading OTC stocks,

Choose the SuperMontage Execution Priority to best suit your preferences,

Select your own time-out settings for each order routing venue, and,

Accelerate order entry time by customizing a default Quantity field value.

Of course, as with every CyberTrader Pro window, the fonts and colors can be adjusted to help you create an interface that's comfortable to look at while using screen space efficiently.

Send Orders Faster

For traders who prefer keyboard shortcuts to pointing and clicking, CyberTrader Pro's Hot Key capabilities can help you get orders underway in a hurry.

Hot Key Stocks—Load frequently watched stocks quickly by assigning stocks to your keyboard number pad, or by assigning a short alias (A instead of ABC).

Hot Key Executions—Assign an entire execution scheme to a single keystroke. You can set up an order to buy, sell, or short via any of CyberTrader's available routing venues, including a Delta adjustment (even specifying whether to calculate the price from the bid or ask), and when you're ready to trade, activate the scheme with the keystroke you select.

Access Real-Time Market Intelligence

Our Data Delivery Methods

Rather than relying on third-party data services, CyberTrader engineers designed its own cutting-edge system that receives data directly from the exchanges, ECNs, and other providers and disseminates the data to all the CyberTrader platforms in real-time.

This system provides a multitude of advantages over using third-party data:

Reliability—All testing, maintenance, and upgrades are done in-house by the very developers who designed it, which means no waiting for a third party to resolve data issues.

Speed—By processing data received directly from the source, rather than from an intermediary who has already processed the data, the information gets to your screen that much faster.

Cost Savings—By reducing our dependence on a third-party data provider, we are able to keep service and innovation at a maximum while keeping commissions at a minimum.

This system provides real-time data for U.S. equities (Level I and Level II), indexes, options, futures, news and charts (historical and real-time tick and intraday charts). Data is sent directly from NYSE, AMEX, Nasdaq, OPRA, and CME; ECN Book data comes directly from ARCA, BRUT, and INET; and news comes from Dow Jones Newswire™ and Comtex.

Analyze Price Movements

Technical analysis is the cornerstone of many traders' strategies, but often the tools for analyzing price and volume movements are complex and difficult to learn. CyberTrader Pro, however, meets the challenge of providing vast amounts of data in an efficient, user-friendly, and customizable format.

CyberCharts can be customized to suit your trading style and aesthetic preferences, from the font size and line colors to the period length of each line in a study. The following are a few other ways CyberCharts can be customized:

Tab Navigation—Because screen real estate is so precious, CyberTrader Pro allows multiple charts within each charting window. You set the chart time frame, studies and other details, give your chart a name, and then you can quickly tab between several charts while only having one chart window open.

Graph Styles—CyberCharts allow you to choose between the most popular graph styles: Bar, Candlestick, Line, and Point & Figure, including customizable P&F Box size and Reversal settings. Each style offers a unique visualization of the timeframe being viewed.

Chart Types—Chart types available are Tick, Intraday, Daily, Weekly and Monthly.

With CyberTrader Pro, you can keep up to 20 chart windows open at one time.

The foundation for technical analysis is in the studies applied to the charts. CyberTrader Pro offers more than 25 studies, most with customizable periods and other settings, and all with the ability to be placed either in a separate panel below the chart or overlaid on the chart. The following studies are available:

Adaptive RSI

Average DM (ADX)

Average True Range (ATR)

Bollinger Bands

CCI

Directional Movement (DX)

DM (+DI)—Positive

DM (−DI)—Negative

Envelope

MACD

MACD—Histogram

Momentum

Money Flow

Money Flow Percent Moving Avg—Exponential

Moving Avg—Simple

On Balance Volume

Options Historical Volatility

Pivot Points (Intraday)

Rate of Change

Relative Strength Index

Signal Line

Stochastic—% D

Stochastic—% Slow

Stochastic—% K

Stochastic RSI

Volume

Williams % R

In addition to studies, the following features aid in analyzing a stock's movements:

Overlays—To help provide some perspective on the movements of a stock over a period of time, CyberCharts can display the chart for an index or another stock on top of the main chart.

Trend Lines—Regular, Fibonacci fan and retracement, and Best fit (regression) trend lines provide several methods for determining short- and long-term trends in a stock's price. Trend lines are adjustable so you can adjust them as performances change.

Support/Resistance Lines—Find out if a stock has broken through a price barrier using support and/or resistance lines.

Monitor Market Momentum

Dynamic Ticker

CyberTrader Pro's Tickers are powerful tools that allow you to get instant “signals” based on the activity of every Market Maker, ECN or Exchange for a stock or list of stocks. With the Dynamic Ticker, you can create or import a list of stocks to monitor, while the Position Ticker displays stocks in which you currently hold a position.

As the signals (such as changes to participants' quotes, quote refreshes, participants leaving or joining the bid/ask, etc.) are sent to the tickers, you can view them as streaming text. Or you can turn on the graphical display, which assimilates these signals and converts them to three basic signals:

Activity Rate (represented by R: in the window) graph displays the amount of market participant activity that has occurred for a particular symbol over the last time frame by counting the number of messages that have scrolled through the Ticker for that stock.

Net Value (represented by V: in the window) graph shows the sum of all the signal weights for a particular symbol over the last time frame by summing the green (+1) and red (−1) messages that have scrolled through the window for each stock.

Rate Adjusted Value, also called the Score, (represented by S: in the window) combines a symbol's Activity Rate and Net Value into a single strength value.

You can view one or all of these signals for each stock in your Dynamic or Position Ticker, and you can make a variety of adjustments, such as changing the weight of certain signals in the calculations, modifying settings to favor more thinly or heavily traded stocks, etc.

Filtering Tools

CyberTrader Pro offers powerful technical analysis tools to help you identify new opportunities amidst the market “noise”. Each tool offers visual cues of market changes that you want to know about, so you may take action quickly—potentially locking in gains and limiting losses.

Print Ticker: See through the market “noise” with the Print Ticker, a tool that may help simplify the way you watch prices change on the securities you track most. It filters through large volumes of market data to help you identify the small, incremental, real-time market changes that are critical to active traders. View the quantity, trade price, and change from open or close for up to 250 stock, index, and futures symbols of your choice. For even greater insight into the market, you can open up to six Print Ticker windows at one time. Each ticker can contain up to four tabs, equipped with different stock lists to expand your view of the market. Customizable, this tool allows you to create a list of the securities you track most, or load one of the pre-created stock, index, or futures symbol lists available in the platform.

Scan Ticker: Prepare for market momentum changes with the Scan Ticker. This real-time streaming tool alerts you when block trades are executed, potentially identifying trading activity from large players. Also, let it search for print or quote changes based on specific volume size or price increments. Just enter the stock, futures, or index symbols that you want to monitor, select your specifications and keep an eye on the tool for notification of any trades that meet your query criteria. For even greater insight into the market, open up to four Scan Ticker windows at one time.

Technical Analysis Matrix™ Tool: Stay focused and aware of potential trading opportunities in a specific security with the Technical Analysis Matrix tool. This tool monitors the performance of a stock or index symbol that you want to watch carefully in real time, and compares it to a broad range of technical analysis strategies. See when real-time technical analysis directional crossovers occur—with an indicator crossing either the stock price or a second indicator. Use the matrix to compare and analyze possible up or down trends in the security's performance for over 30 technical analysis strategies, including Relative Strength Index, Exponential Moving Average, Williams % R, and Stochastics. For a more complete view, use all six available time intervals (bar sizes) to monitor a security's performance.

Technical Analysis Ticker™ Tool: The Technical Analysis Ticker tool offers advanced technical analysis capabilities to help you find trading opportunities among large quantities of market data in real-time. It analyzes trade thresholds and continuously updates throughout the trading day. With the Technical Analysis Ticker tool, you can quickly identify thresholds being crossed for over 8,000 securities and indices using over 30 technical analysis strategies tick by tick. A customizable tool, you select the technical strategy, time interval, type of security, and price/volume filters that work for your trading style.

Manage Risk

Keeping a close watch on your open positions and your account balances can be pivotal to trading successfully. Having an abundance of useful statistics about your trading activity, both intraday and historically, helps you learn from mistakes and repeat your successes. CyberTrader Pro provides several tools designed to help keep unnecessary risk from undermining your success.

Manage Your Account

CyberTrader Pro's Account Manager helps keep track of your account balances and allows you to close or cancel executed and open orders. Your account status is represented by the following classifications, and can be set to automatically open the tab that applies to the status of your order, so you are always looking at the most relevant information:

Orders—Shows every order placed today, where and how it was routed, and whether or not it executed. You can also cancel pending orders from the Orders tab.

Executions—Shows an electronic trade sheet listing all of today's executions.

Trades—Shows an electronic trade sheet listing all of today's completed trades (buy+sell) with the profit and loss of each round trip.

Opens—Shows your current portfolio of positions, including maintenance requirements, quantity, and price. You can also simultaneously close or cancel multiple positions from this tab.

When trading options, the Opens tab displays which positions are being paired within all of your multi-leg strategies. Our sophisticated, real-time pairing logic automatically and optimally pairs your strategies, ensuring that requirements are minimized and available trading capital is maximized. Requirements are automatically calculated and updated anytime you enter a trade, or when you request an update through the Account Manager. You can even drill down on a position to see exactly how the requirement is being calculated.

Alerts—Allows you to manage and view the status of your alerts. Create custom alerts for stocks, options, and futures that are as simple or complex as you need. Select the criteria that will cause the alert to fire, as well as the action the alert will take. You can choose to have the alert simply notify you that your conditions have been met, or route a Buy, Sell, or Short order for you.

Stats—The Account Manager also keeps a few real-time Statistics at your fingertips, including Overnight, Intraday and Real-Time Buying Power; Money Used; Open, Closed, and Total P&L; the current number of pending orders, executions, open positions, and active alerts; and finally, the dollar value of commissions paid today.

You can also open a separate Open Positions window to simultaneously view open positions and orders, executions, trades, alerts, or statistics.

Learn from Experience

Reviewing your trading history and intraday statistics can be essential for learning what strategies are or are not working for you, as well as for keeping a record of your trading activity.

The Portfolio Manager displays many of the same statistics as the Account Manager, but with a more detailed breakdown of intraday statistics, the ability to query historical trading activity, as well as providing a graphical depiction of your portfolio broken down by sector and/or stock symbol.

Intraday Statistics view shows:

A net worth breakdown (starting, real-time, change in, margin equity %, etc.),

A profit & loss summary showing total P&L, biggest gain and loss still open, and biggest gain and loss closed today,

Breakdowns between long and short trades, so you can see which strategies worked for you today,

Trade statistics, such as total number of trades, profitable trades, day trades, number of shares per trade, etc.

Commission and fee summary, and,

Profitability ratios, such as avg. profit divided by average loss and the profit/commissions ratio.

Stay Alert

CyberTrader Pro offers a sophisticated alert and conditional order system that allows you to keep several “eyes” on the market at once. To help you manage risk, alerts can be conveniently entered from the Stock Box or the Account Manager.

Place Conditional Orders from Your Stock Box

Risk management is critical; that's why we have made CyberXchange Trailing Stop orders available from the Stock Box. Now placing a Trailing Stop conditional order can be done quickly and easily. Its convenient location in the platform can help you lock in gains and minimize losses.

For example, imagine you are long 100 shares of WXYZ at 10.50 and you set a CyberXchange Trailing Stop sell order set to trail by 1 point. Then the price of WXYZ goes up to 15, but subsequently dips back down to 8. With a CyberXchange Trailing Stop order, your order would have become a CyberXchange market order to sell as soon as the price dropped to or below 14 (one point of the highest bid of 15).

Set Alerts from Your Account Manager

Using the Alerts tool (which is managed from the Account Manager window) you can perform three major tasks:

Set the system to alert you when your conditions are met (such as a certain stock meeting a price target or a specific position losing a certain % of its market value);

Send an order to close a position when your conditions are met;

Send an order to open a position when your conditions are met.

Alerts can also be made “persistent.” This means that your alert resides on our servers. Therefore, you can log off of the trading platform while your alert remains active.

Additionally, the Alert Templates feature allows you to create alert “shells” that can be quickly activated from several CyberTrader windows, such as the Market View, Top 10, Highs/Lows, Charts, etc. Several templates come installed with the software, or you can design your own. This is useful when you frequently use the same conditions and/or actions for an alert, as it allows you to quickly apply the alert with the parameters already filled in.

Build Watches on Your Criteria

CyberTrader Pro's stock screener, CyberQuant, is fully customizable to help you find opportunities that might ordinarily be off your radar. By setting up one or several of the 130 available filters, you can design a query to seek out stocks that fall within the parameters you desire.

Some of the types of filters available include price and volume statistics, technical analysis values (SMA, EMA, RSI, etc.), financial data (earnings, P/E ratios, dividend, shares outstanding, etc.), analyst recommendations, and industry/sector categorizations.

Two display types are available for viewing the results of your CyberQuant query:

The List display shows the resulting stocks in a grid, so that you can sort by column and easily see data for each stock in the list. Like in the Market View, you can customize which columns you wish to view.

The Graph display is more complex and displays the results of your query as plot points on a 5-dimensional grid—X, Y, Z, size, and color (of each plot point). Each dimension can be represented by any of the 130 filters.

See What Others are Trading

CyberTrader Pro offers several order flow tools that can provide insight into which stocks are being traded more heavily and on which venue:

Executed ECN Orders—Displays all the executed (matched) orders reported from the INET ECN.

Open ECN Orders—Displays all posted orders (not matched) reported from the INET ECN.

Order Executions—Displays all SuperMontage, ECN, and NYSE orders executed through CyberTrader.

Trader Order Flow—Displays all orders and executions of CyberTrader clients.

Get Breaking News and up to the Minute Research

CyberTrader Pro's News tool not only displays real-time “hot” news, but also allows you to search up to five prior days of news for a particular symbol, as well as set up a news watch list to highlight headlines for a list of symbols you specify.

The News window can be set to emit an audible alert when new headlines arrive in any of the news tabs, which can alert you to potential opportunities for new trades or potential risks to current positions. As with all CyberTrader functions, flexibility and speed are paramount. As such, both news and research for a stock can be accessed in most CyberTrader Pro windows by right-clicking on a symbol and selecting either Query for News on [symbol] or Research [symbol]. Clicking on Research will link you to your favorite stock research site.

Sharpen Your Edge

In 2002 and 2003, Forbes magazine named CyberTrader the best brokerage for hyperactive traders. CyberTrader earned this recognition because of our commitment to offering our clients easily accessible, high-quality education tools and training courses.

Trading Simulators

We believe that greater awareness of your platform features and practice using your platform will help make you a more successful trader. Thus, you can use the Simulator†† or Demo‡ mode (in your platform) to practice your trading strategies with real market data.

The Simulator uses recorded market data so you can refine your skills risk-free 24 hours per day, 7 days a week. Access the Simulator at: http://www.cybertrader.com/cybertrader/dem sim.asp. If you are a client, you can also use the Demo mode in your platform to “paper trade” with live data during market hours without risk. To access the Demo mode, click “Demo” instead of “Live Logon” when you log on to CyberTrader Pro.

Courses, Tutorials & Seminars

To brush up on market basics and technical analysis, or share your experiences with other CyberTraders in a chat room, we offer additional self-paced tutorials, live training courses, and a community forum—all accessible from the Trader Resources section of our website at: http://www.cybertrader.com/ctu/traderesources/.

The self-paced tutorials and live classes examine the psychology of trading, how the markets work, entering orders, using the software, new client orientation, and more. In addition, we offer online seminars hosted by CyberTrader's Chief Market Strategist, Ken Tower, CMT, on topics including technical analysis, risk management, and stock selection.

What is claimed is:

1. A computer-implemented method for assisting in a commodity transaction in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein said improvement includes the acts of: setting a target interval for said analysis step; providing a real-time data feed to said processor, said real-time data feed providing information for at least one of said set of arrays; and performing said analysis step at each target interval, wherein a notification of said user takes place at a multiple of said target interval.

2. The method as recited in claim 1, wherein said target interval is set manually.

3. The method as recited in claim 1, wherein said target interval is set automatically based on a trader-chosen factor.

4. The method as recited in claim 1, wherein said target interval is adjusted by shortening the interval.

5. The method as recited in claim 1, wherein said target interval is adjusted by shortening or lengthening said interval based on computational constraints.

6. The method as recited in claim 6, wherein said computational constraints are monitored.

7. The method as recited in claim 6, wherein said real-time feed is also fed to a commodity trading computer.

8. The method as recited in claim 7, wherein said target interval is shortened based on information flagged from said real-time data feed to said commodity trading computer, said commodity trading computer instructing said processor to shorten said target interval.

9. A computer-implemented method for assisting in an equity trade in which a processor is executing instructions that perform the following acts: selecting from a group of mathematical operators to transform a set of arrays located in data storage; performing said mathematical operations of a set of arrays, such that preliminary data is produced; analyzing said preliminary data with a first set of Baeysian-logic functions, each with a corresponding adjustable weights; and determining a recommendation for said equity based on said Baesyian logic analysis, and reporting said recommendation to a user as output; and comparing an actual result for said equity to said recommendation and adjusting at least one of said Bayesian logic function corresponding weights for any future recommendation, wherein the improvement includes that acts of: providing a real-time data feed to said processor; monitoring said preliminary data for a set of contingency notification conditions; and if a set of one or more of said contingency notification conditions is met, communicating with a user that a set of conditions have been met.

10. The method as recited in claim 9, further including the act of setting an adjustable risk profile for at least one equity trader.

11. The method as recited in claim 10, further including the act of publishing stop loss and take profit levels generated by executable instructions.

12. The method as recited in claim 9, further comprising the step of setting a target interval for performing said monitoring step.

13. The method as recited in claim 12, wherein said target interval is set manually.

14. The method as recited in claim 12, wherein said target interval is set automatically based on a trader-chosen factor.

15. The method as recited in claim 12, wherein said target interval is adjusted by shortening the interval.

16. The method as recited in claim 12, wherein said target interval is adjusted by shortening or lengthening said interval based on computational constraints.

17. The method as recited in claim 16, wherein said computational constraints are monitored.

18. The method as recited in claim 9, wherein said real-time feed is also fed to a commodity trading computer.

19. The method as recited in claim 18, wherein said target interval is shortened based on information flagged from said real-time data feed to said commodity trading computer, said commodity trading computer instructing said processor to shorten said target interval.
